(19) United States
(12) Patent Application Publication
(10) Pub. No.: US 2006/0155390 A1
(43) Pub. Date: Jul. 13, 2006

(54) Appliance combination lock for special modes

(75) Inventor: Mitchell N. Corbett, Urbandale, IA (US)

Correspondence Address: MCKEE, VOORHEES & SEASE, P.L.C.;ATTN: MAYTAG/ WHIRLPOOL, 801 GRAND AVENUE, SUITE 3200, DES MOINES, IA, 50309-2721, US

(73) Assignee: Maytag Corporation, Newton, IA (US)

(21) Appl. No.: 11/033,336

(22) Filed: Jan. 11, 2005

(51) Int. Cl. G05B 11/01; H01H 9/28; H01H 9/26; G05B 15/00; G08B 21/00

(52) U.S. Cl. 700/17; 700/83; 340/686.1; 200/50.34; 200/43.12

(57) ABSTRACT

An appliance is provided with special software modes for diagnostic or testing purposes. The appliance includes an electronic control panel with a rotary dial for actuating the special modes. The dial operates like a combination lock. The dial is rotated clockwise so as to twice pass a reference point, then rotated counterclockwise to pass the reference point once, and then again rotated clockwise to the selected special mode, as indicated by a plurality of LED lights extending around the dial.

### BACKGROUND OF THE INVENTION

It is known to provide diagnostic and testing modes in appliances, such as clothes washing machines, dryers and dish washers, to allow a service person to test or repair the machine. Normally, the diagnostic modes are entered by actuating switches on the control panel, either in a sequential pattern, simultaneously, or for a preset time period. Such keyed actuation of switches is subject to human error, and thus an incorrect mode can be easily made. Erroneous actuation of modes wastes time and costs money.

Accordingly, a primary objective of the present invention is the provision of an improved system for actuating special modes on appliances.

Another objective of the present invention is the provision of an appliance having a rotary dial for actuating special modes.

Another objective of the present invention is the provision of an appliance having a combination lock dial for actuation of special diagnostic modes.

A further objective of the present invention is the provision of an appliance having a rotary encoder which is rotated in a first direction, then an opposite second direction, and then again in the first direction so as to actuate a special mode of the appliance.

Another objective of the present invention is the provision of an appliance having a rotary dial for actuating special appliance modes, with LED lights extending around the dial to indicate the selected mode.

A further objective of the present invention is the provision of an appliance having a rotary dial which is quickly and easily operated in the manner of a combination lock to actuate selected special modes of the appliance.

These and other objectives will become apparent from the following description of the invention.

### BRIEF SUMMARY OF THE INVENTION

An appliance, such as a washing machine, includes a plurality of special software modes for diagnostic purposes. Electronic controls are provided for actuating the special modes. The electronic controls include a rotary dial operatively connected to an encoder so as to select one of the modes. A series of LED lights extend around the dial so as to indicate the selected mode. The rotary dial is operated in the manner of a combination lock, which is rotated in opposite directions before the mode is selected. The dial is rotated in a first direction past a reference point, and then in the opposite direction past the reference point. Lastly, the dial is rotated in the first direction again to the selected mode, as indicated by one of the LEDs.

### BRIEF DESCRIPTION OF THE DRAWINGS

FIG. 1 is a perspective view of a washing machine with a control panel having the combination lock rotary dial of the present invention.

### DETAILED DESCRIPTION OF THE PREFERRED EMBODIMENT

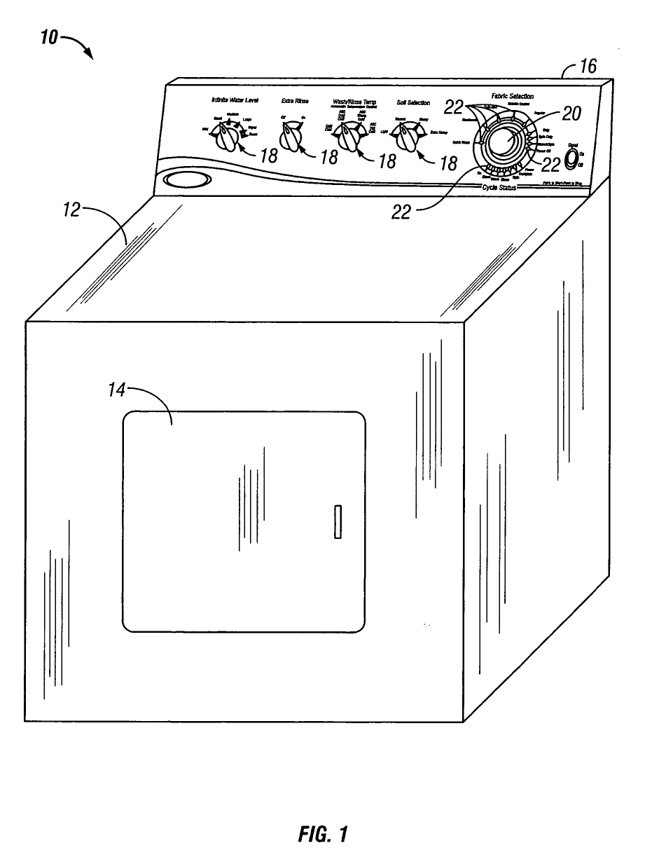

FIG. 1 shows an appliance 10, such as a washing machine or dryer. Other appliances are also within the scope of the present invention. The appliance 10 includes a cabinet 12 with a door 14 to provide access to the interior of the appliance 10. The door 14 may be on the front of the appliance 10, as shown in FIG. 1, or on the top of the appliance 10. The appliance includes a control panel 16 with operating dials 18 or buttons, for selecting the normal operation of the machine.

The present invention is directed towards a rotary dial 20 which is used for selecting special software modes of the appliance. For example, the software modes may be for diagnostic or testing purposes. The rotary dial 20 is operatively connected to a rotary encoder within the control panel 16, which in turn is operatively interfaced with the software modes. A plurality of light emitting diodes (LED) 22 extend around the dial 20 to indicate the various special modes which may be selected.

The rotary dial 20 operates in a manner similar to a combination lock. More particularly, the rotary dial 20 is rotated in a first direction past a reference point, such as the twelve-o-clock position on the dial. Preferably, the dial 20 must be rotated twice in the first direction past the reference point. Then, the rotary dial 20 is rotated in the opposite direction past the reference point. Lastly, the rotary dial is rotated again in the first direction until aligned with the desired LED, so as to actuate the selected mode and illuminate the LED. Preferably, the first direction of rotation of the rotary dial is clockwise, as with a conventional combination lock. Each LED 22 around the dial 20 is assigned a different special mode or function. Printed information for the specialty modes is stored on a tip sheet in a convenient location, which may be within the appliance 10.

With the combination lock dial 20 of the present invention, the special modes and functions of the appliance 10 can be accessed by service people or testers. The LED 22 lights to indicate the selected special mode of the appliance 20. A visual indication of the users progress during rotation of the dial 20 is preferably provided by illuminating the associated LEDs 22. Alternately, rotational progress may be indicated via a physical marking on the dial 20.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An appliance, comprising:
a plurality of special software modes for diagnostic purposes;
electronic controls for actuating the special modes, including a rotary dial to select one of the modes and LED extending around the dial to indicate the selected mode.

2. The appliance of claim 1 wherein the rotary dial is a combination lock which is rotated in opposite directions before the mode is selected.

3. The appliance of claim 2 wherein the dial is rotated in a first direction past a reference point, then in the opposite direction past the reference point, and then again in the first direction to the selected mode.

4. The appliance of claim 3 wherein the dial is rotated initially in the first direction two times past the reference point.

5. The appliance of claim 1 wherein the dial is operatively connected to a rotary encoder.

6. The appliance of claim 1 wherein there is one LED for each mode.

7. A method of actuating special software modes in an appliance, comprising:
rotating a dial on the appliance in a first direction past a reference point; then
rotating the dial in an opposite second direction past the reference point; and then
rotating the dial in the first direction to a desired mode indicated around the dial, whereby the selected mode is actuated.

8. The method of claim 7 wherein the dial is first rotated in the first direction twice past the reference point.

9. The method of claim 7 further comprising illuminating one of a plurality of LED around the dial to designate the selected mode.

10. The method of claim 7 further comprising storing information about each mode on a tip sheet.

11. A control panel for an appliance, comprising:
a rotary dial which is rotated in opposite directions past a reference point before being rotated to select from a plurality of operational modes of the appliance.

12. The control panel of claim 11 further comprising a plurality of LED surrounding the dial, with each of the appliance modes corresponding to one of the LED.

13. The control panel of claim 11 wherein the dial includes a rotary encoder.

14. The control panel of claim 11 further comprising a tip sheet containing information about the modes of the appliance.
